(19) United States
(12) Patent Application Publication
(10) Pub. No.: US 2005/0068267 A1
(43) Pub. Date: Mar. 31, 2005

(54) Plasma display panel and plasma display device

(75) Inventors: Toshihiro Yoshioka, Tokyo (JP); Akifumi Okigawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC PLASMA DISPLAY CORPORATION

(21) Appl. No.: 10/950,414

(22) Filed: Sep. 28, 2004

(30) Foreign Application Priority Data
Sep. 29, 2003 (JP) 2003-338883

(51) Int. Cl. G09G 3/28

(52) U.S. Cl. 345/60

(57) ABSTRACT

A PDP (plasma display panel) and a plasma display device are provided which are capable of improving a light-emitting characteristic and of realizing high image quality by incorporating a discharge electrode using a low-resistance conductive material. In the above PDP, connecting electrode portions each being arranged in the vicinity of a transparent conductive portion of a scanning electrode and a transparent conductive portion of a sustaining electrode, where sustaining discharge is made to occur for displaying of images, have a slender-line shape and their film thickness being comparatively small in order to decrease a light-shielding rate and low-resistance conductive portions each being arranged in a portion being comparatively far from each of transparent conductive portions have their film thickness being comparatively large in order to lower wiring resistance.

### BACKGROUND OF THE INVENTION

1. Field of the Invention

The present invention relates to a plasma display panel (hereinafter simply referred to as a “PDP”) and a plasma display device using the PDP and more particularly to the plasma display panel and the plasma display device using the PDP which has a low-resistance thin film or thick film containing metal as a main component to induce occurrence of discharge, as a discharge electrode.

The present application claims priority of Japanese Patent Application No. 2003-338883 filed on Sep. 29, 2003, which is hereby incorporated by reference.

2. Description of the Related Art

A plasma display device having a PDP as its main component, in general, since it has many advantages in that, when compared with conventionally-used display devices such as a CRT (Cathode Ray Tube) device, an LCD (Liquid Crystal Display) device, or a like, less flicker occurs, a display contrast rate is larger, displaying on a larger screen is made possible, it can be made thinner, it can give a quicker response, or a like, is being widely and increasingly used as a display device for an information processing device such as a computer, flat screen TV (Television), or a like, in recent years.

A PDP is roughly classified, depending on its operating method, into two types, one being an AC-type PDP whose electrode is coated with a dielectric layer and which is operated indirectly in an alternating-current discharge state and another being a DC (Direct Current)—type PDP whose electrode is exposed in discharge space and which is exposed in discharge space and is operated in a direct-current discharge state. The AC-type PDP, in particular, has a comparatively simple structure and can realize displaying on a large area with ease and, therefore, it is being widely used. Such the PDP is basically constructed so as to be made of a front substrate and a rear substrate, both being made up of a transparent material such as glass or a like, in a manner in which the two substrates face each other and discharge gas space placed between both the substrates in which plasma is generated is formed.

Among the AC-type PDPs, a three-electrode surface-discharge AC-type PDP is the most widely used. In the three-electrode surface-discharge AC-type PDP, groups of row electrodes each group being made up of two or more scanning electrodes and two or more sustaining electrodes (common electrode), both the scanning electrodes and sustaining electrodes being arranged in parallel to one another along a row direction are formed on an inner face of the front substrate being one substrate making up a pair of the above substrates and a group of column electrodes being arranged in a manner orthogonal to the row direction is formed on an inner face of the rear substrate being another substrate. A reason why the three-electrode surface-discharge AC-type PDP is the most widely used is that, since an ion of high energy being generated while surface discharge occurs on the front substrate does not collide with a phosphor layer formed on the inner face of the rear substrate, a life of the PDP can be made longer.

The PDP making up a main component of the three-electrode surface-discharge AC-type plasma display device (hereinafter simply called a plasma display device) is so constructed that, writing discharge for selecting a cell to be displayed (to be lit) is made to occur between one of the scanning electrodes on the front substrate and one of the data electrodes on the rear substrate and then sustaining discharge (displaying discharge) is made to occur by surface discharge in the selected cell between one of the scanning electrodes on the front substrate and one of the sustaining electrodes on the front substrate. Also, a color display device by using such the PDP in which red (R), green (G), and blue (B) color phosphor layers are arranged in an inner face of the rear substrate is provided which is capable of emitting multi-colors.

FIG. 19 is a perspective view illustrating configurations of a conventional PDP (first conventional technology) making up a main component of the plasma display device described above. FIG. 20 is a plan view showing configurations of a front substrate of the conventional PDP of FIG. 19. FIG. 21 is a cross-sectional view taken along a line I-I of FIG. 20. The PDP 100, as shown in FIG. 19, is so constructed that a front substrate (first substrate) 101 and a rear substrate (second substrate) 102 face each other and discharge gas space 103 is formed between the front substrate 101 and the rear substrate 102. The front substrate 101, as shown in FIG. 19, has a first insulating substrate 104 made of a transparent material such as a glass or a like, a group of row electrodes (first electrode group) made up of two or more scanning electrodes 105 and of two or more sustaining electrodes 106 placed in an inner face of the first insulating substrate 104 in parallel to one another along a row direction H, both the scanning electrode 105 and the sustaining electrode 106 facing each other with a surface discharge gap 107 (FIG. 20) being interposed between the scanning electrode 105 and the sustaining electrode 106, a transparent dielectric layer 108 made of glass of a low-melting point such as PbO (lead oxide) with which the group of row electrodes being made up of two or more scanning electrodes 105 and of two or more sustaining electrodes 106 are coated, and a protecting layer 109 made of MgO (magnesium oxide) or a like to be used for protection of the transparent dielectric layer 108 from discharge. Each of the scanning electrodes 105, as shown in FIG. 19 to FIG. 21, has a transparent electrode 105A on a part of which a bus electrode 105B (also called a trace electrode) is formed which is used to reduce electrical resistance in the transparent electrode 105A and each of the sustaining electrodes 106, as shown in FIG. 19 to FIG. 21, has a transparent electrode 106A on a part of which a bus electrode 106B (also called a trace electrode) is formed which is used to reduce electrical resistance in the transparent electrode 106A.

On the other hand, the rear substrate 102, as shown in FIG. 19, has a second insulating substrate 111 made of glass or a like, a group of electrodes (second electrode group) made up of two or more data electrodes (address electrodes) 112 arranged on an inner face of the second insulating substrate 111 in a column direction V, a white dielectric layer 113 to cover each of the data electrodes 112, a rib (partition wall) 114 to provide the above mentioned discharge gas space 103 in which discharge gas such as He (helium), Ne (neon), Xe (xenon) or a like is filled in a single or mixed state and each being made of glass of a low melting point and being formed to partition each discharge cell and phosphor layers 115 each being formed at bottom faces and wall faces of each of the ribs 114 and each is made up of a red phosphor layer, a green phosphor layer, and a blue phosphor layer, each of which converts ultraviolet rays generated by discharge of discharge gas into visible light. Two or more cells 110 (hereinafter simply called a cell 110) each being formed at an intersecting point between each of the row electrode groups and each of column electrode groups in a matrix manner in the row direction H and the column direction V. In the case of displaying in monochrome, one pixel is made up of one cell. In the case of color displaying, one pixel is made up of three cells (one cell emitting red color light, second cell emitting green color light, and third cell emitting blue color).

A conventional POP (second conventional technology) is disclosed, for example, in Japanese Patent Application Laid-open No. 2002-150951 and in Reference “IDW 2002, pgs 765-768” in which each of scanning electrodes and sustaining electrodes making up the first electrode group on the front substrate is constructed of a low-resistance conductive portion only, not of transparent conductive portion. FIG. 22 is a plan view of configurations of a front substrate of the conventional PDP 120 of FIG. 19. FIG. 23 is a cross-sectional view taken along a line J-J of FIG. 22. As shown in FIG. 22 and FIG. 23, in the conventional PDP 120, each of the scanning electrode 105 and sustaining electrode 106 has a low-resistance conductive portion 116 made of a low-resistance conductive material formed so as to have a mesh-like shape.

As shown in FIG. 19 to FIG. 21, each of transparent conductive portions 105A and 106A attached to each of the scanning electrode 105 and sustaining electrode 106 employed in the conventional PDP 100 fabricated according to the first conventional technology is made up of a transparent conductive material such as ITO (Indium Tin Oxide), SnO₂ (Tin Oxide), or a like. Each of a low-resistance conductive portion 105B of the scanning electrode 105 and a low-resistance conductive portion 106B of the sustaining electrode 106 in the conventional PDP 100 (first technology) shown in FIG. 19 to FIG. 21 and each of low-resistance conductive portions 116 of the scanning electrode 105 and of the sustaining electrode 106 in the conventional PDP 120 (second technology) shown in FIG. 22 and FIG. 23 use a metal film or a layer-stacked film such as Ag (silver), Al (aluminum), Cu (copper), Cr (chromium), or a like, or a thick film of a photosensitive conductive paste containing Ag particles or a like as the low-resistance conductive material. Approximately the same material as the low-resistance conductive material described above is used as a material for the data electrode 112 shown in FIG. 19. Moreover, since configurations of the rear substrate 102 are apparent from FIG. 19, descriptions of configurations of the rear substrate in FIGS. 21 and 23 are omitted.

When the low-resistance conductive portions 105B and 106B of the scanning electrode 105 and the sustaining electrode 106, respectively, in the conventional PDP 100 and the low-resistance conductive portions 116 in the conventional PDP 120 are to be constructed of a metal thin film or layer-stacked film made up f any low-resistance conductive material, after having formed 1 the metal thin film or the layer-stacked film in an inner face of the first insulating substrate 104, patterning is performed, using a resist pattern, on the metal thin film or the layer-stacked film so as to have a desired shape by an etching method or by a lift-off method. On the other hand, when the above low-resistance conductive portions 105B, 106B, and 116 are to be constructed of a photosensitive conductive paste, after having applied the photosensitive conductive paste to an inner face of the first insulating substrate 104, patterning is performed on the photosensitive conductive paste so as to have a desired shape by using a photolithography method. In the case in which the low-resistance conductive portions 105B and 106B in the conventional PDP 100 and the low-resistance conductive portions 116 in the conventional PDP 120 are fabricated by using any one of the above methods, a thick film of each of the obtained low-resistance conductive portions is formed to have approximately a uniform shape as a whole.

However, such the conventional PDPs described above have a problem. That is, since the obtained thick film of the low-resistance conductive portions making up each of the electrodes is of approximately a uniform shape as a whole, a light-emitting characteristic (light-emitting efficiency) is degraded and it is impossible to achieve high image quality.

It is desirous that the low-resistance conductive portions 105B and 106B of the scanning electrode 105 and sustaining electrode 106 in the conventional PDP 100 and the low-resistance conductive portions 116 of the scanning electrode 105 and sustaining electrode 106 in the conventional PDP 120 are so configured that their wiring resistance (electrode resistance) is made as small as possible to suppress an increase in a discharge voltage and light emitted from an inside of a cell is not intercepted to keep its light-emitting characteristic excellent. To lower the wiring resistance, it is necessary that a conductive material having a small resistance is used, or widths of the slender and mesh-like low-resistance conductive portions 105B, 106B, and 116 formed in the row direction H and their film thicknesses are made large. To prevent light emitted from a cell from being intercepted, a wiring area (electrode area) has to be made small so, that a ratio of non-transparent areas of the low-resistance conductive portions 105B, 106B, and 116 to a cell light-emitting area is made as small as possible.

However, since low-resistance conductive portions 105B, 106B, and 116 of the scanning electrode 105 and sustaining electrode 106 in the conventional PDPs 100 and 120 are formed so as to have approximately a uniform shape as a whole, if a film thickness is made large to fully lower the wiring resistance, processing of making their lines slender becomes difficult and, as a result, a light-shielding rate increases which causes luminance to be lowered. Since a film thickness of the dielectric layer 108 used to cover each of the low-resistance conductive portions 105D, 106B, and 116 is made small, an ultraviolet light generating efficiency by discharge is lowered which, as a result, degrades the light-emitting characteristic. On the other hand, if the film thickness is made small in order to make their lines slender with ease, the wiring width has to be made large in order to avoid an increase in the wiring resistance, which, as a result, causes an increase in a light-shielding rate.

Thus, when each of the low-resistance conductive portions 105B, 106B, and 116 of the scanning electrode 105 and sustaining electrodes 106 employed in the conventional PDPs 100, 120 is so formed as to have approximately a uniform film thickness, if the film thickness is forced to become large in order to fully reduce wiring resistance, a light-shielding rate increases and, if the film thickness is forced to become small in order to avoid an increase in the light-shielding rate, wiring resistance increases, that is, compatibility between achievement of reducing the wiring resistance and achievement of decreasing the light-shielding rate is difficult. Therefore, in the conventional PDPs 100, 120, problems occur in that a light-emitting characteristic decreases which makes it difficult to realize high image quality.

### SUMMARY OF THE INVENTION

In view of the above, it is an object of the present invention to provide a PDP and a plasma display device which is capable of improving a light-emitting characteristic and of realizing high image quality by incorporating a discharge electrode using a low-resistance conductive material.

According to a first aspect of the present invention, there is provided a plasma display panel including:
a first substrate and a second substrate arranged so as to face each other, with discharge gas space being interposed between the first substrate and the second substrate;
a first electrode group made up of two or more scanning electrodes and two or more sustaining electrodes formed on a face of the first substrate facing the second substrate, with a discharge gap being interposed between pairs each being made up of one of the two or more scanning electrodes and one of the two or more sustaining electrodes, in parallel to one another along a first direction;
a second electrode group made up of two or more data electrodes on a face of the second substrate facing the first substrate in a second direction orthogonal to the first direction; and
a discharge cell formed at an intersecting point between the first electrode group and second electrode group;
wherein both each of the two or more scanning electrodes and each of the two or more sustaining electrodes are made up of a transparent conductive portion and a low-resistance conductive portion having a thin film or a thick film containing a metal as a main component and wherein the low-resistance conductive portion is made up of two regions each having, at least, two different film thicknesses in the unit discharge cell.

In the foregoing, a preferable mode is one wherein the transparent conductive portion and the low-resistance conductive portion are electrically connected to each other via a connecting electrode portion.

Another preferable mode is one wherein the connecting electrode portion is constructed by using a low-resistance conductive material and a film thickness of the connecting electrode portion is smaller than that of the low-resistance conductive portion.

Still another preferable mode is one wherein a partition wall is formed on the second substrate and the connecting electrode portion is formed in a manner in which the partition wall and the connecting electrode portion are arranged in a manner in which the partition wall and the connecting electrode portion overlap each other or a part of or entire of the second low-resistance conductive portion is placed in a region other than a discharge region partitioned by the partition wall in a manner in which the partition wall and the second low-resistance conductive portion.

An additional preferable mode is one wherein a film thickness of the connecting electrode portion or a film thickness of the mesh-like shaped the first low-resistance conductive portion is approximately 5 μm or less.

A further preferable mode is one wherein a film thickness of the connecting electrode portion or a thickness of a line making up the mesh-like shaped the first low-resistance conductive portion is approximately 20 μm or less.

According to a second aspect of the present invention, there is provided a plasma display panel including:
a first substrate and a second substrate arranged so as to face each other, with discharge gas space being interposed between the first substrate and the second substrate;
a first electrode group made up of two or more scanning electrodes and two or more sustaining electrodes formed on a face of the first substrate facing the second substrate, with a discharge gap being interposed between pairs each being made up of one of the two or more scanning electrodes and one of the two or more sustaining electrodes, in parallel to one another along a first direction;
a second electrode group made up of two or more data electrodes on a face of the second substrate facing the first substrate in a second direction orthogonal to the first direction; and
a discharge cell formed at an intersecting point between the first electrode group and second electrode group;
wherein both each of the two or more scanning electrodes and each of the two or more sustaining electrodes are made up of only a low-resistance conductive portion having a thin film or a thick film containing metal as a main component and wherein the low-resistance conductive portion is made up of two regions each having, at least, two different film thicknesses in the unit discharge cell.

In the foregoing, a preferable mode is one wherein the low-resistance conductive portion is made up of a first low-resistance conductive portion formed so as to have a mesh-like shape and of a second low-resistance conductive portion being electrically connected to the first low-resistance conductive portion, the first and second low-resistance conductive portions both having a thin film or a thick film containing metal as a main component.

Another preferable mode is one wherein one of the mesh-like shaped the first low-resistance conductive portion and another of the mesh-like shaped the first low-resistance conductive portion face each other with the discharge gap being interposed between the two mesh-like shaped the low-resistance conductive portions.

Still another preferable mode is one wherein a film thickness of the mesh-like shaped the first low-resistance conductive is smaller than that of the second low-resistance conductive portion.

A further preferable mode is one wherein a partition wall is formed on the second substrate and the connecting electrode portion is formed in a manner in which the partition wall and the connecting electrode portion are arranged in a manner in which the partition wall and the connecting electrode portion overlap each other or a part of or entire of the second low-resistance conductive portion is placed in a region other than a discharge region partitioned by the partition wall in a manner in which the partition wall and the second low-resistance conductive portion.

A still further preferable mode is one wherein a film thickness of the connecting electrode portion or a film thickness of the mesh-like shaped the first low-resistance conductive portion is approximately 5 μm or less.

Also, a preferable mode is one wherein a film thickness of the connecting electrode portion or a thickness of a line making up the mesh-like shaped the first low-resistance conductive portion is approximately 20 μm or less.

Also, a preferable mode is one wherein a film thickness of the first mesh-like shaped low-resistance thin film or thick film containing metal as a main component is large in part.

According to a third aspect of the present invention, there is provided a plasma display device including:
a plasma display panel including: a first substrate and a second substrate arranged so as to face each other, with discharge gas space being interposed between the first substrate and the second substrate: a first electrode group made up of two or more scanning electrodes and two or more sustaining electrodes formed on a face of the first substrate facing the second substrate, with a discharge gap being interposed between pairs each being made up of one of the two or more scanning electrodes and one of the two or more sustaining electrodes, in parallel to one another along a first direction; a second electrode group made up of two or more data electrodes on a face of the second substrate facing the first substrate in a second direction orthogonal to the first direction; and a discharge cell formed at an intersecting point between the first electrode group and second electrode group; wherein both each of the two or more scanning electrodes and each of the two or more sustaining electrodes are made up of a transparent conductive portion and a low-resistance conductive portion having a thin film or a thick film containing a metal as a main component and wherein the low-resistance conductive portion is made up of two regions each having, at least, two different film thicknesses in the unit discharge cell;
a controlling circuit to control the plasma display panel; and
an interface circuit to make a format conversion of an image signal and to feed the format-converted image signal to the controlling circuit.

According to a fourth aspect of the present invention, there is provided a plasma display device including;
a plasma display panel including: a first substrate and a second substrate arranged so as to face each other, with discharge gas space being interposed between the first substrate and the second substrate; a first electrode group made up of two or more scanning electrodes and two or more sustaining electrodes formed on a face of the first substrate facing the second substrate, with a discharge gap being interposed between pairs each being made up of one of the two or more scanning electrodes and one of the two or more sustaining electrodes, in parallel to one another along a first direction; a second electrode group made up of two or more data electrodes on a face of the second substrate facing the first substrate in a second direction orthogonal to the first direction; and a discharge cell formed at an intersecting point between the first electrode group and second electrode group; wherein both each of the two or more scanning electrodes and each of the two or more sustaining electrodes are made up of only a low-resistance conductive portion having a thin film or a thick film containing metal as a main component and wherein the low-resistance conductive portion is made up of two regions each having, at least, two different film thicknesses in the unit discharge cell;
a controlling circuit to control the plasma display panel; and
   an interface circuit to make a format conversion of an image signal and to feed the format-converted image signal to the controlling circuit.

With the above configuration, compatibility between achievement of reducing the wiring resistance and achievement of decreasing the light-shielding rate is made possible. A light-emitting characteristic is improved and to realize high image quality becomes possible.

### BRIEF DESCRIPTION OF THE DRAWINGS

The above and other objects, advantages, and features of the present invention will be more apparent from the following description taken in conjunction with the accompanying drawings in which:

FIG. 1 is a plan view showing configurations of a POP according to a first embodiment of the present invention;

FIG. 2 is a cross-sectional view of the PDP taken along a line A-A in FIG. 1;

FIG. 3 is a process diagram showing a manufacturing method of the PDP shown in FIG. 1 in the order of processes;

FIG. 4 is a plan view showing configurations of a PDP according to a second embodiment of the present invention;

FIG. 5 is a cross-sectional view of the PDP taken along a line B In FIG. 4;

FIG. 6 is a plan view showing configurations of a PDP according to a third embodiment of the present invention;

FIG. 7 is a cross-sectional view of the PDP taken along a line C-C in FIG, 6;

FIG. 8 is a plan view showing configurations of a PDP according to a fourth embodiment of the present invention;

FIG. 9 is a cross-sectional view of the PDP taken along a line D-D in FIG. S;

FIG. 10 is a plan view showing configurations of a PDP according to a fifth embodiment of the present invention;

FIG. 11 is a cross-sectional view of the PDP taken along a line E-E in FIG. 10;

FIG. 12 is a plan view showing configurations of a PDP according to a sixth embodiment of the present invention;

FIG. 13 is a cross-sectional view of the PDP taken along a line F-F in FIG. 12;

FIG. 14 is a plan view showing configurations of a PDP according to a seventh embodiment of the present invention;

FIG. 15 is a cross-sectional view of the PDP taken along a line G-G in FIG. 14;

FIG. 16 is a plan view showing configurations of a PDP according to an eighth embodiment of the present invention;

FIG. 17 is a cross-sectional view of the PDP taken along a line H-H in FIG. 16;

FIG. 18 is a schematic block diagram showing configurations of a plasma display device of a ninth embodiment of the present invention;

FIG. 19 is a perspective view illustrating configurations of a conventional PDP (first conventional technology);

FIG. 20 is a plan view showing configurations of a front substrate of the conventional PDP of FIG. 19;

FIG. 21 is a cross-sectional view of the PDP taken along a line I-I of FIG. 20;

FIG. 22 is a plan view of configurations of a front substrate of another conventional PDP (second conventional technology); and

FIG. 23 is a cross-sectional view of the PDP taken along a line J-J of FIG. 22.

### DETAILED DESCRIPTION OF THE PREFERRED EMBODIMENTS

Best modes of carrying out the present invention will be described in further detail using various embodiments with reference to the accompanying drawings. In the PDP of the present invention, each connecting electrode portion placed in a vicinity between transparent conductive portions of a scanning electrode and a sustaining electrode where sustaining discharge is made to occur for displaying images is so constructed as to have a comparatively small film thickness in order to decrease a light-shielding rate and each of the low-resistance thin films or thick films containing iron as a main component (hereinafter simply called a low-resistance conductive portion) placed in a position being comparatively far from each of the transparent conductive portions is so constructed as to have a comparatively large film thickness in order to lower wiring resistance.

### First Embodiment

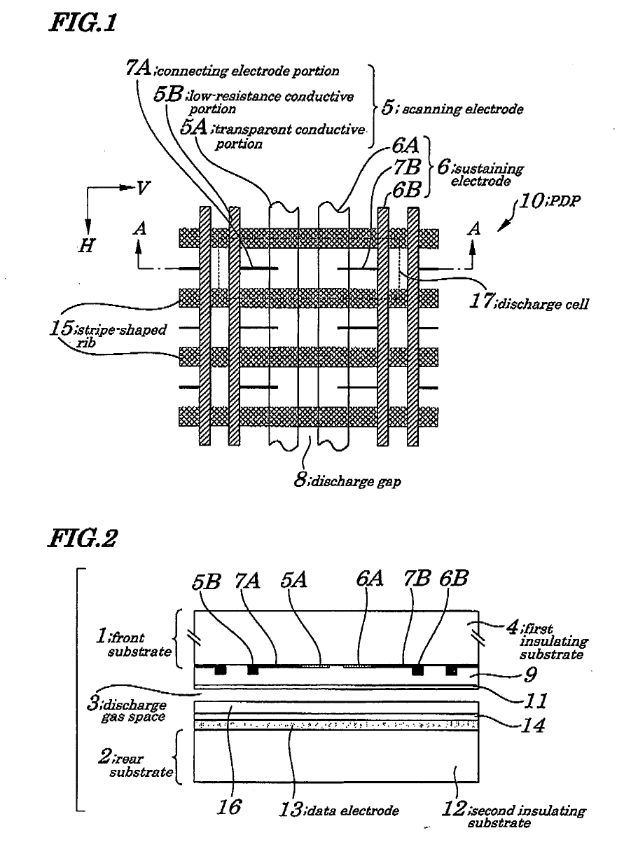

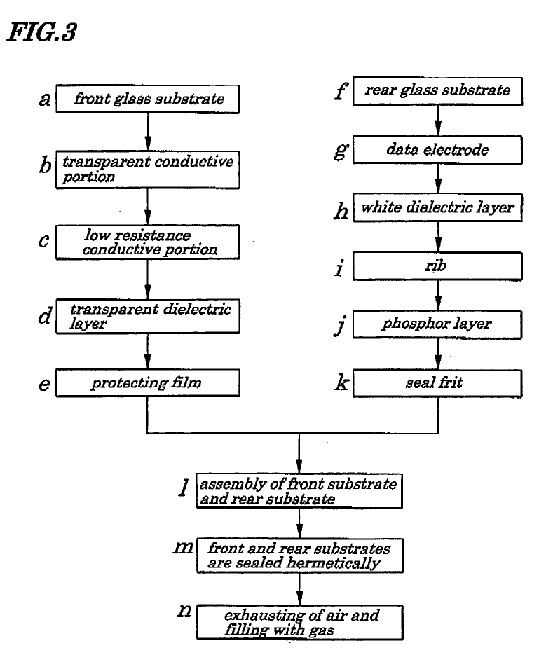

FIG. 1 is a plan view showing configurations of a PDP 10 according to a first embodiment of the present invention. FIG. 2 is a cross-sectional view of the PDP 10 taken along a line A-A in FIG. 1. FIG. 3 is a process diagram showing a manufacturing method of the PDP 10 shown in FIG. 1 in the order of processes. The PDP 10, as shown in FIG. 1 and FIG. 2, has a basic configuration that a front substrate (first substrate) 1 and a rear substrate (second substrate) 2 are arranged so as to face each other and discharge gas space 3 is formed between the front substrate 1 and the rear substrate 2. The front substrate 1 includes a first insulating substrate 4 made up of a transparent material such as glass or a like, a group of row electrodes (first electrode group) made up of two or more scanning electrodes 5 and sustaining electrodes 6 being arranged in an inner face of the first insulating substrate 4 in parallel to one other along the row direction H with a discharge gap 8 interposed between each of the scanning electrodes 5 and the scanning electrodes 6, and a transparent dielectric layer 9 made of low-melting point glass containing PbO used to coat each of the scanning electrodes 5 and sustaining electrodes 6 as a main component, inorganic oxide, nitride film, or a like, and a protecting film 11, made of MGO or a like, to protect the transparent dielectric layer 9 from discharge.

Each of the scanning electrodes 5 making up the group of row electrodes is made up of a transparent conductive portion 5A, a low-resistance conductive portion (bus electrode or trace electrode) 5B, and a connecting electrode portion 7A, and each of the sustaining electrodes 6 making up the group of the row electrodes is made up of a transparent conductive portion 6A, a low-resistance conductive portion (bus electrode or trace electrode) 6B, and a connecting electrode portion 7B, in which the transparent conductive portions 5A and 6A are arranged in parallel to each other in a row direction H with the discharge gap 8 interposed between the transparent conductive portions 5A and 6A, the low-resistance conductive portions 5 and 6B are arranged in parallel to each other in the row direction H and the connecting electrode portions 7A and 7B are arranged in a column direction V to electrically connect the transparent conductive portions 5A and 6A to the low-resistance conductive portions 5B and 6B. Each of the transparent conductive portions 5A and 6A is constructed by using a transparent conductive material having a film thickness of 100 μm to 200 μm such as ITO, and NESA glass containing SnO₂ (tin oxide film) as a main component. Also, each of the low-resistance conductive portions 5B and 6B is constructed by using a photosensitive conductive paste containing Ag particles or a like having a film thickness and width of 5 μm to 20 μm as a low-resistance conductive material. Each of the connecting electrode portions 7A and 7B is constructed by using a photosensitive conductive paste containing Ag particles or a like having a film thickness and width of 1 μm to 5 μm as a low-resistance conductive material.

The PDP 10 of the first embodiment shown in FIG. 1 differs from those in the conventional examples in that both the low-resistance conductive portions 5B and 6B, both being made up of low-resistance conductive materials, have a film thickness being different from that of both the connecting electrode portions 7A and 7B, both being also made up of low-resistance conductive materials. That is, in the embodiment, the connecting electrode portions 7A and 7B placed in the vicinity of the transparent conductive portion 5A of each of the scanning electrodes 5 and the transparent conductive portion 6A of each of the sustaining electrodes 6, respectively, have a comparatively small film thickness in order to decrease a light-shielding rate and the low-resistance conductive portions 5B and 6B being placed comparatively far from the transparent conductive portions 5A and 6A, respectively, have a comparatively large film thickness in order to reduce wiring resistance.

Next, methods for forming the low-resistance conductive portions 5B and 68 (each being called a “first conductive portion”) and the connecting electrode portions 7A and 7B (each being referred to as a “second conductive portion”) in a manner in which the portions 5B and 6B have a film thickness being different from that of the portions 7A and 7B are described.

(1) A first method is to form the first and second conductive portions separately. For example, first, after having applied a photosensitive conductive paste containing Ag particles or a like so as to have a comparatively small film thickness or after a metal thin film has been formed, by performing a patterning operation using a photolithography method in a manner to have a desired shape, the first conductive portion having a comparatively small film thickness is formed. Next, after having applied a photosensitive conductive paste containing Ag particles or a like, by performing a patterning operation using the photolithography method in a manner to have a desired shape, the second conductive portion having a comparatively large film thickness is formed. Moreover, after the second conductive portion has been formed by the way as described above, the first conductive portion may be formed.

(2) A second method is one in which, after having formed a second conductive portion having a comparatively large film thickness, by using an ink-jetting method or by a deposition method, a first conductive portion having a comparatively small film thickness is formed. After having first formed the first conductive portion by the way as described above, the second conductive portion may be formed.

(3) A third method is one in which only a portion to serve as a second conductive portion having a comparatively large film thickness has been coated with a photosensitive conductive paste containing Ag particles or a like so as to have a comparatively large film thickness, a full plate exposure method is executed to form a first conductive portion and a second conductive portion. The above method in which only the portion serving as the second conductive portion having a comparatively large film thickness has been coated with the photosensitive conductive paste containing Ag particles or a like so as to have a comparatively large film thickness includes one in which, after having coated an entire portion serving as the conductive portion with the photosensitive conductive paste having a relative thin thickness, a conductive portion containing a part serving as the second conductive portion having a comparatively large film thickness is painted with a photosensitive conductive paste by using a pattern printing method or a like. In this state, when the conductive portion is formed so as to have a two-layer structure by using a black and white material or a like, the portion to serve as the first conductive portion having a comparatively small film thickness may be formed so as to have only one layer (black material). When exposure and development operations are performed on photosensitive conductive pastes of different film thicknesses, if an exposure condition required to make lines slender is different, by using a mask (half-tone mask) of patterns each having different transmittance of an ultraviolet ray to be used for exposure, it is possible to realize an optimum amount of exposure depending on each area having various thicknesses. In the case of a large film thickness, unless an amount of exposure is made fully large, patterning is difficult. However, in the case of a thin film thickness, when a large amount of exposure is used, a pattern becomes thick. To solve this problem, by using the half-tone mask, low-resistance conductive portions 5B and 6B serving as the first conductive portion and the connecting electrode portions 7A and 7B serving as the second conductive portion can be exposed and formed by a proper amount of exposure by one-time exposure using one piece of a mask.

On the other hand, the rear substrate 2 has a second insulating substrate 12 made up of a transparent material such as glass or a like, a group of column electrodes (second electrode group) made up of two or more data electrodes 13 (address electrodes) and arranged in an inner face of the second insulating substrate 12 in a column direction V, a white dielectric layer 14 to cover each of the data electrodes 13, stripe-shaped ribs (partition walls) 15 formed along the column direction V and made up of a glass of a low-melting point which provides the above discharge gas space 3 being filled with discharge gas such as He, Ne, Xe, or a like in a single or mixed manner and which partitions each discharge cell 17, and a phosphor layer 16 being formed in a position to cover bottom faces and wall faces of each of the ribs 15 and made up of a red phosphor layer, a green phosphor layer, and a blue phosphor layer, all of which convert an ultraviolet ray generated by discharge of discharge gas to visible light. At an intersecting point among the group of row electrodes and the group of the column electrodes is formed each of two or more discharge cells 17 formed in a matrix form in a row direction H and a column direction V.

The PDP 10 of the embodiment is manufactured according to a manufacturing process as shown in FIG. 3. First, in the process (a), the front glass substrate 1 is prepared as the first insulating substrate 4. Next, in the process (b), after a film made of ITO or a like has been formed in an inner face of the first insulating substrate 4 by using a sputtering method, by performing patterning on the film so as to have a desired shape by a photolithography method, each of transparent conductive portions 5A and 6A is formed. Then, in the process (c), after having applied a photosensitive conductive paste by a screen printing method and having formed an Al film or a like by the sputtering method, and by performing a patterning operation on the Al film to have a desired shape to form each of the low-resistance conductive portions 5B and 6B and each of the connecting electrode portions 7A and 7B, fabrication of the scanning electrode 5 and sustaining electrode 6 are completed. Then, in the process (d), by using a screen printing method or a like, the transparent dielectric layer 9 made up of glass of a low-melting point containing PbO as a main component, inorganic oxide, a nitride thin film, or a like is formed in a manner in which the transparent dielectric layer 9 covers the scanning electrode 5 and sustaining electrode 6. Then, in the process (e), a protecting film 11 made of a MgO film is formed to complete the fabrication of the front substrate 1.

On the other hand, in the process (f), the rear glass substrate 2 is prepared as the second insulating substrate 12. Next, in the process (g), after having formed an Al film in an inner face of the second insulting substrate 12 by the sputtering method or a like, patterning is performed by the photolithography method so as to have a desired shape to form the data electrode 13. Then, in the process (h), the white dielectric layer 14 is formed by the screen printing method in a manner in which the white dielectric layer 14 covers the data electrode 13. Next, in the process (i), the stripe-shaped rib 15 is formed on the data electrode 13 by the screen printing method. Then, in the process (j), a phosphor layer 16 is formed in a manner in which the phosphor layer 16 covers the white dielectric layer 14 and the stripe-shaped rib 15. Then, in the process (k), a sealing frit (not shown in FIGS. 1 and 2) is formed by the screen printing method to complete the fabrication of the rear substrate 2.

Next, in the process (l), the front substrate 1 and rear substrate 2 are assembled in a manner in which the front substrate 1 and the rear substrate 2 face each other, in a fixed state, with a gap of approximately 100 μm being interposed between the substrates 1 and 2. Then, in the process (m), portions surrounding both the front substrate 1 and rear substrate 2 are sealed hermetically with the sealing frit (sealing agent). Then, in the process (n), air existing between the front and rear substrates 1 and 2 is exhausted and the gap between the substrates 1 and 2 is filled with gas. An air vent is formed at a proper place in the second insulating substrate 12 making up the rear substrate 2 and a vent pipe (not shown) is attached, in a state of being sealed hermetically, on an outer surface of the second insulating substrate 12 with the vent pipe being aligned with the air vent. An end portion of the vent pipe positioned on a side being opposite to an end portion of the vent pipe being attached to the rear substrate 1 is opened in an initial state and the vent pipe is connected via the end portion to an air exhausting and gas filling device.

First, by using the air exhausting and gas filling device, after air has been exhausted from the discharge gas space to produce a vacuum, the discharge gas space is filled with discharge gas. After completion of filling the space with discharge gas, the vent pipe is chipped on due to heating and the end portion of the opened portion is blocked. Thus, the discharge gas space is filled with discharge gas and the fabrication of the PDP 10 is completed.

A comparison of a light-emitting characteristic is performed between the PDP 10 in which the film thicknesses of the low-resistance conductive portions 5B and 6B both being made up of a low-resistance conductive material and the film thicknesses of the connecting electrode portions 7A and 7B are different from each other, as in the case of the first embodiment, and a PDP (comparative example) in which the film thicknesses of the above low-resistance conductive portions 5B and 6B and the film thicknesses of the connecting electrode portions 7A and 7B are approximately the same. As a result, it is confirmed by the comparison that, in the first embodiment, the film thicknesses of the connecting electrode portions 7A and 7B each being formed in the vicinity of each of the transparent conductive portions 5A and 6A existing in a light-emitting area are smaller than those of the low-resistance conductive portions 6B and 6B each being formed in a position being far from each of the transparent conductive portions 5A and 6A and, therefore, a light-shielding rate decreases, which enables improvement of the light-emitting characteristic. Also, it is confirmed by the comparison that, in the first embodiment, since the film thickness of the transparent dielectric layer 9 formed on the connecting electrode portions 7A and 7B can be made approximately the same as that of transparent dielectric layer 9 formed on the transparent conductive portions 5A and 5A, degradation of the light-emitting characteristic caused by an increase in a discharge current by the connecting electrode portions 7A and 7B can be suppressed. This becomes clearer when the transparent dielectric layer 9 is made thin in particular.

It is also confirmed by the comparison that, in the first embodiment, when the width of each of the connecting electrode portions 7A and 7B is set to be approximately 20 μm or less, preferably 10 μm or less, a light-shielding rate in a light-emitting area of a cell can be fully decreased. It is also confirmed that, by setting the film thickness to be 1 μm to 5 μm, compatibility between achievement of lowering wiring resistance and achievement of decreasing a light-shielding rate is made possible. That is, each of the connecting electrode portions 7A and 7B is arranged in a manner in which each of the connecting electrode portions 7A and 7B and the stripe-shaped rib 15 on the rear substrate 2 overlap so that light-shielding is influenced in general, however, as in the present embodiment, if the connecting electrode portions 7A and 7B and the stripe-shaped rib 15 do not overlap, the light-shielding rate increases which, as a result, causes luminance to be lowered. Generally, in order to decrease the light-shielding rate of a cell aperture portion to be 30% or less, each of the connecting electrode portions 7A and 7B is formed so that the width of each of the connecting electrode portions 7A and 7B is 20 μm or less, preferably 10 μm or less, as described above. A lower limit value of the width is selected which does not cause the disconnection.

Thus, according to the PDP 10 of the first embodiment, each of the connecting electrode portions 7A and 7B, both being made up of a low-resistance conductive material, each being formed in the vicinity of each of the transparent conductive portion 5A of the scanning electrode 5 and the transparent conductive portion 6A of the sustaining electrode 6 is so formed as to have a comparatively small film thickness (for example, lm to 5 μm) in order to decrease a light-shielding rate and each of the low-resistance conductive portions 5B and 6B, both being made up of a low-resistance conductive material, each being formed in a position being far from each of the transparent conductive portions 5A and 6A is so formed as to have a comparatively large film thickness (for example, 5 μm to 20 μm). As a result, compatibility between achievement of lowering wiring resistance and achievement of decreasing a light-shielding rate is made possible. Therefore, in the PDP configured by using the low-resistance conductive material as the discharge electrode, it is made possible to improve a light-emitting characteristic and to realize high image quality.

In a modified embodiment of the first embodiment of the present invention, each of the low-resistance conductive portions 5B and 6B is formed by stacking a black conductive layer made of, for example, ruthenium oxide having a film thickness of 1 μm to 5 μm and a low-resistance conductive layer containing, for example, Ag as a main ingredient having a film thickness of 5 μm to 15 μm. Here, the black conductive layer is formed on a side of the first insulating substrate 4 and is effective in suppressing reflectance occurring when the layer is seen from the face of the display screen. Each of the connecting electrode portions 7A and 7B is constructed of only the black conductive layer. Since the black conductive layer made of such the material as ruthenium oxide can be formed in a manner in which its film thickness is small, each of the connecting electrode portions 7A and 7B can be formed to have a slender-line shape and each of the low-resistance conductive portions 5B and 6B is constructed by stacking the low-resistance conductive material and, therefore, wiring resistance can be fully lowered. Instead of the black conductive layer, a conductive layer being thin and made of Ag particles that can correspond to a high-definition pattern may be used. Also, a thin black conductive layer and a layer stacked film that can be made thin and slender may be used.

Thus, approximately the same effect as obtained in the first embodiment can be achieved by this modified example of the first embodiment.

### Second Embodiment

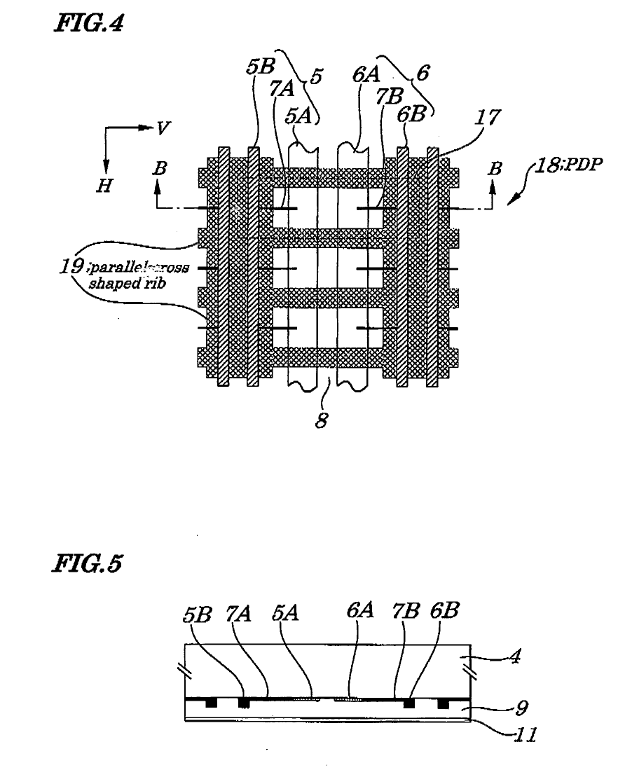

FIG. 4 is a plan view showing configurations of a PDP 18 of a second embodiment of the present invention. FIG. 5 is a cross-sectional view of the PDP 18 taken along a line B-B in FIG. 4. The configurations of the PDP 18 of the second embodiment differ from those of the PDP 10 of the first embodiment in that a rib (partition wall) 19 is formed so as to be of a parallel-cross shape. That is, the PDP 18 of the second embodiment, as shown in FIG. 4, is so configured that its rib 19 placed on a second insulating substrate 12 to provide discharge gas space 3 and to partition each discharge cell 17 is of a parallel-cross shape. Except these, configurations of the PDP 18 are approximately the same as those in the first embodiment. Therefore, in FIGS. 4 and 5, the same reference numbers are assigned to parts corresponding to the configurations in FIGS. 1 and 2 and their descriptions are omitted accordingly. Moreover, a rear substrate 2 is not shown in FIGS. 4 and 5.

By forming the rib 19 having a parallel-cross shape on the second insulating substrate 12 (not shown), since an adverse effect caused by discharge of discharge cells adjacent to one another can be avoided, it is possible to prevent erroneous discharge with reliability.

Thus, approximately the same effect as obtained in the first embodiment can be achieved by the second embodiment. According to the configurations of the embodiment, erroneous discharge occurring among cells being adjacent to one another can be avoided with reliability.

### Third Embodiment

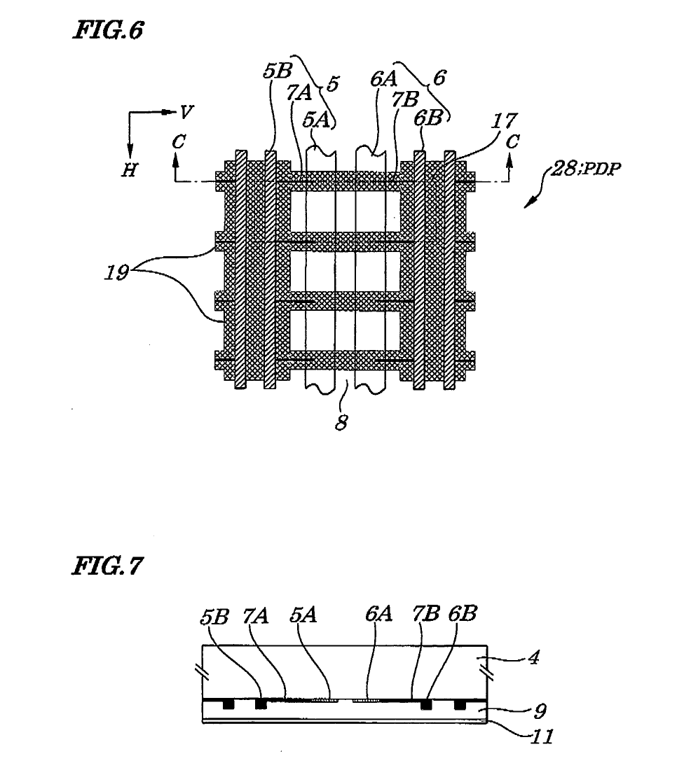

FIG. 6 is a plan view showing configurations of a PDP 28 according to a third embodiment of the present invention. FIG. 7 is a cross-sectional view of the PDP 28 taken along a line C-C in FIG. 6. The configurations of the PDP 28 of the third embodiment differ from those of the PDP 18 of the second embodiment in that parallel-cross shaped ribs 19 and each of connecting electrode portions 7A, 7B are arranged so as to overlap one another. That is, in the PDP 28 of the third embodiment, as shown in FIG. 6, each of the connecting electrode portions 7A and 7B and the parallel-cross shaped ribs 19 formed on a second insulating substrate 12 are arranged so as to overlap one another.

Thus, by arranging the parallel-cross shaped ribs 19 and each of the connecting electrode portions 7A and 7B so that they overlap one another, discharge occurs locally in a position of each of transparent conductive portions 5A and 6A and, therefore, discharge can be made to occur only in a center of a discharge cell 17. In the third embodiment, by forming each of the connecting electrode portions 7A and 7B so as to be thin and to have a slender-line shape, an increase in a light-shielding rate caused by protrusion of each of the connecting electrode portions 7A and 7B out the parallel-cross shaped ribs 19 can be suppressed. By this, an effect of giving a margin to positioning accuracy can be obtained.

Thus, approximately the same effect as obtained in the second embodiment can be achieved by the third embodiment. Additionally, in the third embodiment, it is possible to make discharge occur only in a center portion of a discharge cell 17.

### Fourth Embodiment

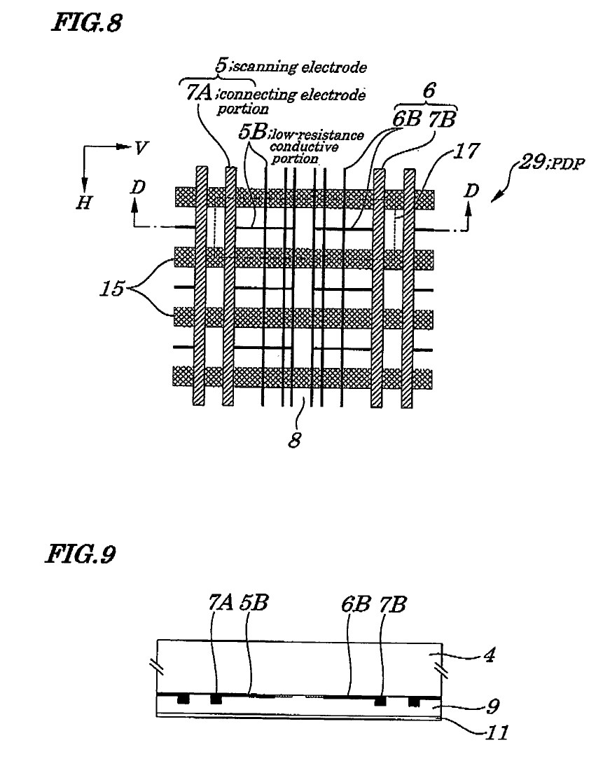

FIG. 8 is a plan view showing configurations of a PDP 29 according to a fourth embodiment of the present invention. FIG. 9 is a cross-sectional view of the PDP 29 taken along a line D-D in FIG. 8. Configurations of the PDP 29 of the fourth embodiment differ greatly from those in the first embodiment in that each of scanning electrodes 5 and each of sustaining electrodes 6, both making up a first group of electrodes on a first substrate 1, are constructed of a low-resistance conductive portion 5B only, without using a transparent conductive portion. That is, in the PDP 29 of the fourth embodiment, as shown in FIGS. 8 and 9, each of the scanning electrodes 5 is made up of the low-resistance conductive portion 5B constructed of a mesh-like shaped low-resistance conductive material and of a connective electrode portion 7A and each of the sustaining electrodes is made up of a low-resistance conductive portion 6B constructed of the same mesh-like shaped low-resistance conductive material as used in the conductive portion 5B and a connecting electrode portion 7B, in which film thicknesses of the low-resistance conductive portions 51 and 6B and of the connecting electrode portions 7A and 7B are different from each other. Here, each of the low-resistance conductive portions 5B and 6B is constructed by using a photosensitive conductive paste having its film thickness and width of 1 μm to 5 μm containing Ag particles or a like as the low-resistance conductive material. Also, each of the connecting electrode portions 7A and 7B is constructed by using a photosensitive conductive paste having its film thickness and width of 5 μm to 10 μm containing Ag particles or a like as the low-resistance conductive material.

A comparison of a light-emitting characteristic is performed between the PDP 29 in which the film thicknesses of the low-resistance conductive portions 5B and 6B both being made up of a low-resistance conductive material and the connecting electrode portions 7A and 7B are different from each other, as in the case of the first embodiment, and a PDP (comparative example) in which the film thicknesses of the above low-resistance conductive portions 5B and 6B and the connecting electrode portions 7A and 7B are approximately the same. As a result, it is confirmed by the comparison that, since the film thickness of the low-resistance conductive portions 5B and 6B both being made up of the low-resistance conductive material is lower than that of the connecting electrode portions 7A and 7B being formed in a position being far from a central place in the light-emitting area, a light-shielding rate is decreased, which, as a result, enables the light-emitting characteristic to be improved. It is also confirmed that, since the film thickness of the transparent dielectric layer 9 on the low-resistance conductive portions 5B and 6B can be made the same as those of the transparent conductive portions 5A and 5B, a decrease in a light-emitting characteristic caused by an increase in a discharge current in the low-resistance conductive portions 5B and 6B can be suppressed. This effect becomes clear when a transparent dielectric layer 9 is made thin.

It is also confirmed by the comparison that, when the width of each of the low-resistance conductive portions 5B and 6B is set to be approximately 20 μm or less, preferably 10 μm or less, the light-shielding rate in a light-emitting area of a cell can be fully decreased. It is also confirmed that, by setting the thickness of each of the low-resistance conductive portions 5B and 6B to be 1 μm to 5 μm, compatibility between achievement of reducing the wiring resistance and achievement of decreasing the light-shielding rate is made possible. Here, by arranging the low-resistance conductive portion, out of the low-resistance conductive portions 5B, in a random way so that the low-resistance conductive portion being formed in a column direction V can play a role of a short bar, the more effective result can be obtained.

Thus, in the PDP 29 of the fourth embodiment, compatibility between achievement of reducing the wiring resistance and achievement of decreasing the light-shielding rate is made possible. Additionally, in the PDP 29 configured by using such the low-resistance conductive material as the discharge electrode, it is made possible to improve a light-emitting characteristic and to realize high image quality.

### Fifth Embodiment

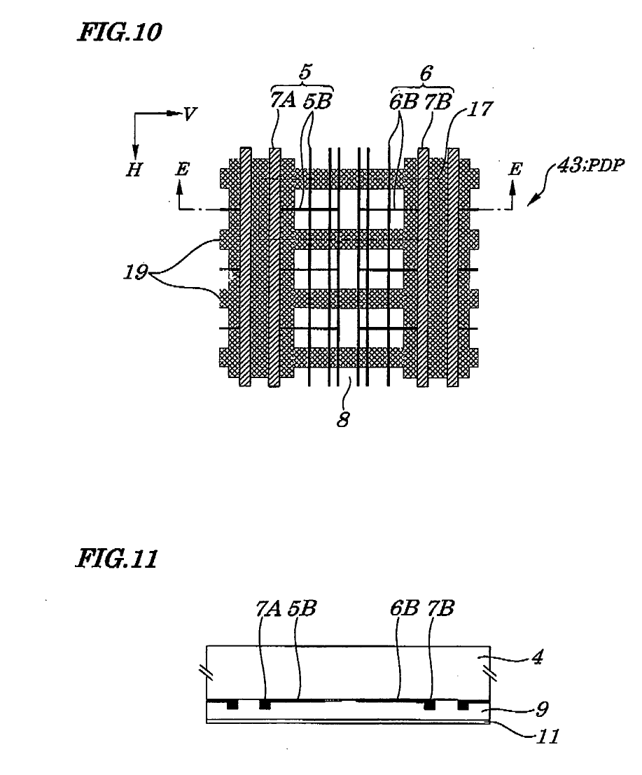

FIG. 10 is a plan view showing configurations of a PDP 43 according to a fifth embodiment of the present invention. FIG. 11 is a cross-sectional view of the PDP 43 taken along a line E-E in FIG. 10. Configurations of the PDP 43 of the fifth embodiment differ from those in the above fourth embodiment in that ribs 19 are so formed as to have a parallel-cross shape. That is, in the PDP 43 of the fifth embodiment, as shown in FIG. 10, the ribs 19 formed above a second insulating substrate 12 to provide discharge gas space 3 and to partition each of discharge cells 17 is so configured as to be of a parallel-cross shape. Except the above, configurations of the PDP 43 are the same as those in the fourth embodiment. In FIGS. 10 and 11, same reference numbers are assigned to corresponding parts in FIGS. 8 and 9 and their descriptions are omitted accordingly.

Thus, by forming the parallel-cross shaped rib 19 above the second insulating substrate 12, since an adverse effect caused by discharge of discharge cells adjacent to one another can be avoided, it is possible to prevent erroneous discharge with reliability.

The approximately same effect obtained in the fourth embodiment can be achieved by the fifth embodiment.

### Sixth Embodiment

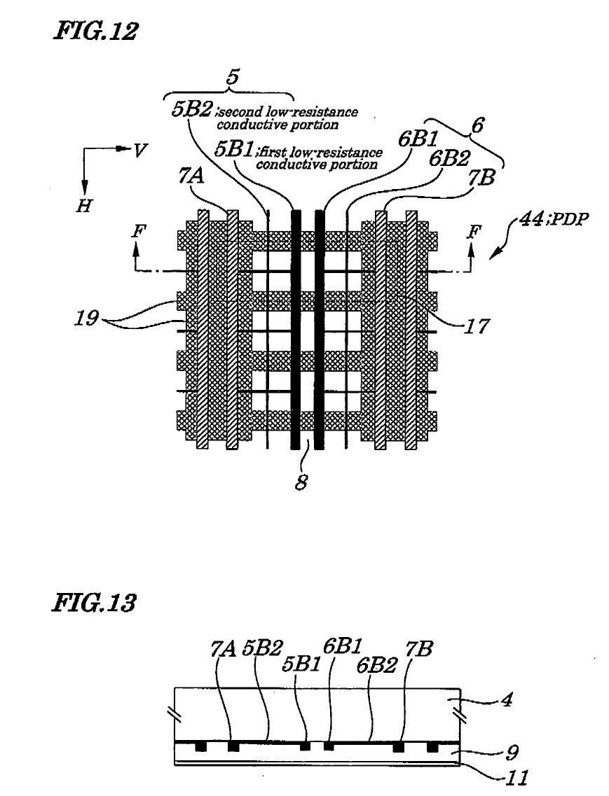

FIG. 12 is a plan view showing configurations of a PDP 44 according to a sixth embodiment of the present invention. FIG. 13 is a cross-sectional view of the PDP 44 taken along a line F-F in FIG. 12. Configurations of the PDP 44 of the sixth embodiment differ from those in the above fifth embodiment in that film thicknesses of low-resistance conductive portions are partially different from one another. That is, each of scanning electrodes 5 has a first low-resistance conductive portion 5B1 arranged in a center position and a second low-resistance conductive portion 5B2 arranged in an outer side of the center position and each of sustaining electrodes 6 has a first low-resistance conductive portion 6B1 arranged in the center position and a second low-resistance conductive portion 6B2 arranged in an outer side of the center position, in which a film thickness of each of the first low-resistance conductive portions 5B1 and 6B1 is larger than each of the second low-resistance conductive portions 5B2 and 6B2. By configuring above, since a film thickness of a transparent dielectric layer 9 to be formed on the first low-resistance conductive portions 5B2 and 6B2 having a thick film can be small, an intense electric field occurs in discharge space and a large amount of wall charges can be formed and, therefore, occurrence of surface discharge is made easy. As a result, a discharge voltage to be made to occur between each of the scanning electrodes 5 and each of the sustaining electrodes 6 can be made low.

Thus, the approximately same effect obtained in the fifth embodiment can be achieved by the sixth embodiment. Additionally, in the PDP 44 configured as above, it is made possible to decrease a discharge voltage being made to occur between each of the scanning electrodes 5 and each of the sustaining electrodes 6.

### Seventh Embodiment

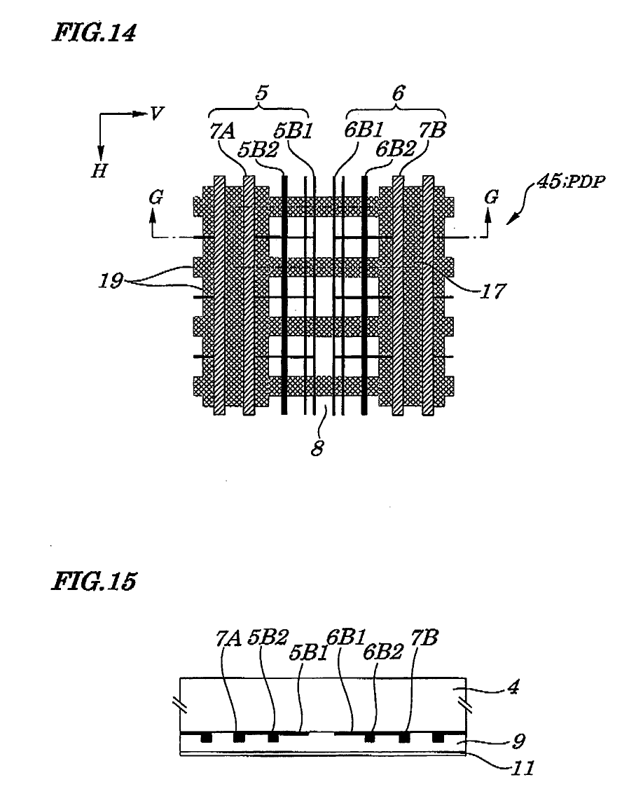

FIG. 14 is a plan view showing configurations of a PDP 45 according to a fifth embodiment of the present invention. FIG. 15 is a cross-sectional view of the PDP 45 taken along a line G-G in FIG. 12. Configurations of the PDP 45 of the seventh embodiment differ from those in the above seventh embodiment in that film thicknesses of low-resistance conductive portions are partially different from one another. That is, in the PDP 45 of the seventh embodiment, each of scanning electrodes 5 has a first low-resistance conductive portion 5B1 arranged in a center position and a second low-resistance conductive portion 5B2 arranged in an outer side of the center position and each of sustaining electrodes 6 has a first low-resistance conductive portion 6B1 arranged in the center position and a second low-resistance conductive portion 6B2 arranged in an outer side of the center position, in which a film thickness of each of the second low-resistance conductive portions 5B2 and 6B2 is larger than each of the first low-resistance conductive portions 5B1 and 6B1. By configuring above, since a film thickness of a transparent dielectric layer 9 to be formed on the first low-resistance conductive portions 5B2 and 6B2 having a thick film can be made thin, a large amount of wall charges can be formed and, therefore, surface discharge can be made to easily occur in the second low-resistance conductive portions 5B2 and 6B2. That is, at the time when discharge having occurred between each of scanning electrodes 5 and each of the sustaining electrodes 6 terminates, amounts of electric charges in this region being left in a protecting film 11 on the second low-resistance conductive portions 5B2 and 6B2 can be made large and optimum charge distribution to improve a driving characteristic and a light-emitting characteristic can be obtained.

Thus, approximately the same effect as obtained in the fifth embodiment can be achieved by the seventh embodiment. Additionally, in the PDP 45 configured as above, an optimum charge distribution to improving a light-emitting characteristic can be obtained.

### Eighth Embodiment

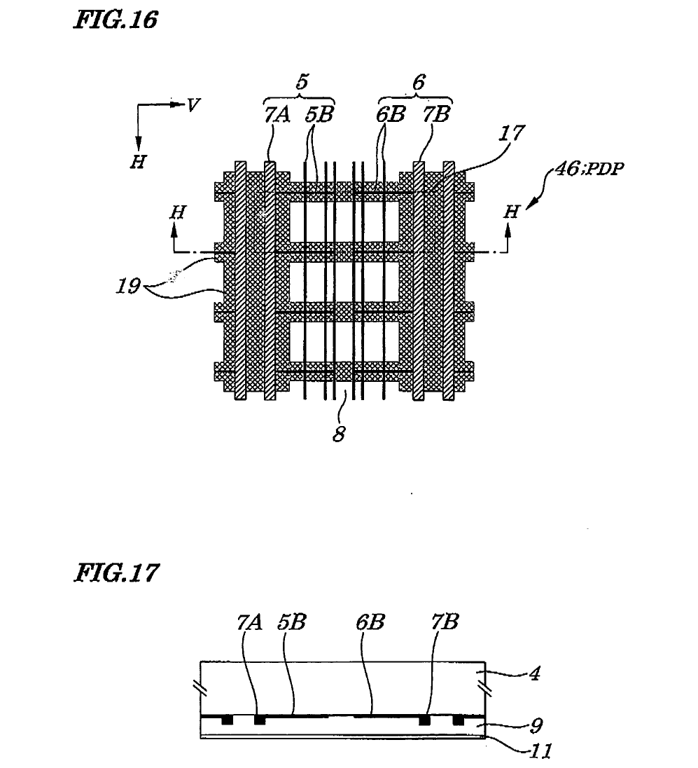

FIG. 16 is a plan view showing configurations of a PDP 46 according to an eighth embodiment of the present invention. FIG. 17 is a cross-sectional view of the PDP 46 taken along a line H-H in FIG. 16. Configurations of the PDP 46 of the eighth embodiment differ from those in the above fifth embodiment in that each of the low-resistance conductive portions formed on a column direction V and ribs 19 having a parallel-cross shape are arranged so as to overlap one another. That is, in the PDP 46 of the eighth embodiment, as shown in FIG. 16, each of low-resistance conductive portions 5B and 6B formed in the column direction V and ribs 19 having a parallel-cross shape formed on a second insulating substrate 12 are arranged so as to overlap one another.

Thus, by placing each of the low-resistance conductive portions 5B and 6B outside a region where display discharge occurs in a manner in which the ribs 19 having the parallel-cross shape and each of the low-resistance conductive portions 5B and 6B formed in the column direction V overlap each other, since discharge occurs locally in a position between the low-resistance conductive portions 5B and 6B both facing each other, it is made possible to make discharge occur only in the center of in a discharge cell 17. In the seventh embodiment, by forming each of the low-resistance conductive portions 5B and 6B in the column direction V so as to be thin and to have a slender-line shape, an increase in a light-shielding rate caused by protrusion of each of the low-resistance conductive portions 5B and 6B out the ribs 19 can be suppressed. By this, an effect of giving a margin to positioning accuracy can be obtained.

Thus, the approximately same effect as obtained in the second embodiment can be achieved by the eighth embodiment. Additionally, in the PDP 46 configured as above, it is possible to make discharge occur only in the center of the discharge cell 17.

### Ninth Embodiment

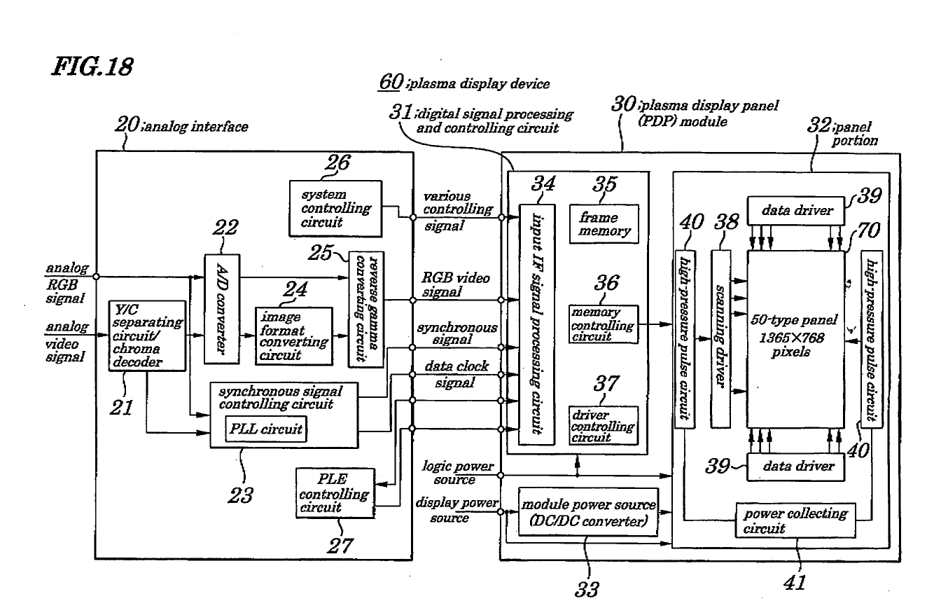

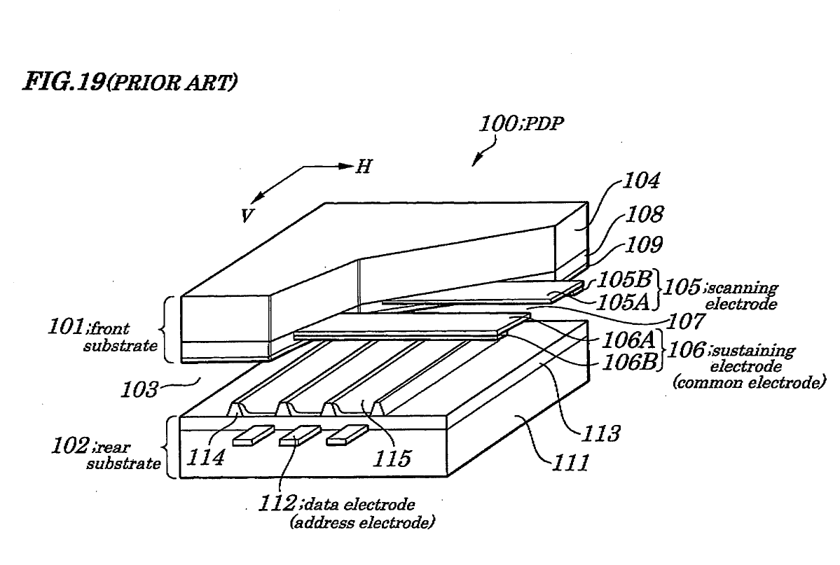

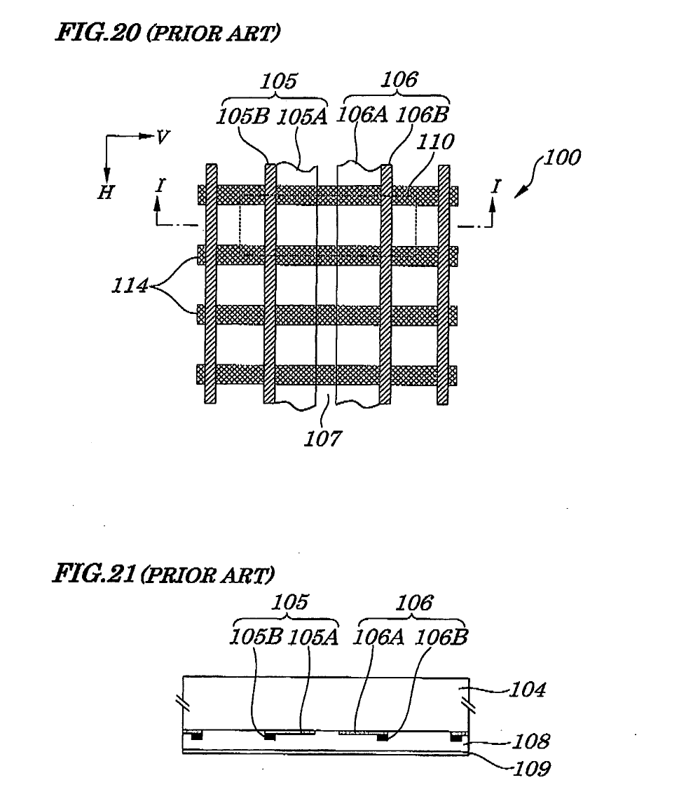

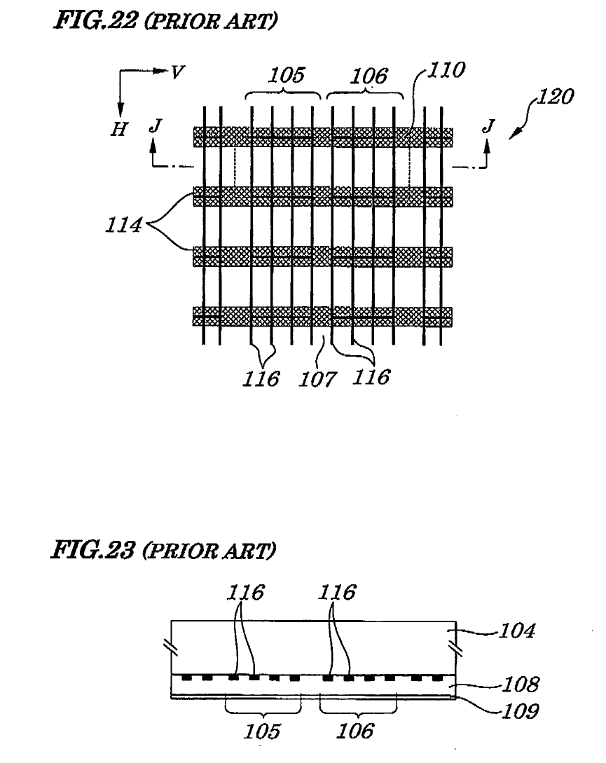

FIG. 18 is a schematic block diagram showing configurations of a plasma display device 60 of a ninth embodiment of the present invention. The plasma display device 60 of the ninth embodiment is fabricated by using the PDPs of the first to eighth embodiments. The plasma display device 60 of the ninth embodiment, as shown in FIG. 18, has an analog interface (IF) 20 and a PDP module 30.

The analog IF 20, as shown in FIG. 18, is made up of a Y/C (Y signal/Color signal) separating circuit 21 having a chroma decoder, an A/D converter 22, a synchronous signal controlling circuit 23 having a PLL (Phase-Locked-Loop) circuit, an image format converting circuit 24, a reverse gamma (γ) converting circuit 25, and a PLE (Peak Luminance Enhancement) controlling circuit 27.

In short, the analog IF 20, after having converted an received analog video signal into a digital video signal, feeds the digital video signal to the PDP module 30. The analog video signal transmitted from, for example, a TV tuner, after having been separated into luminance signals for each of RGB colors by the Y/C separating circuit 21, is converted into a digital signal by the A/D converter 22. Then, when configurations of a pixel to be handled by the PDP module 30 are different from those of a video signal, conversions of a required image format are made by the image format converting circuit 24. A characteristic of display luminance in a PDP is proportional to its input signal, however, corrections (γ) have been, in advance, made to an ordinary video signal in a manner to meet a characteristic of a cathode ray tube (CRT). Therefore, after A/D conversions of a video signal have been made by the A/D converter 22, a reverse gamma conversion of a video signal is made to produce a digital video signal that has been reconstructed so as to have a linear characteristic. The produced digital video signal is output to the PDP module 30 as a RGB video signal.

Since a sampling clock and data clock signal for A/D conversion are not contained in the analog video signal, a PLL circuit being embedded in the synchronous signal controlling circuit 23 produces a sampling clock and outputs it to the PDP module 30, using a horizontal sync signal, as a reference, to be fed at the same time when an analog video signal is fed. The PLE controlling circuit 27 in the analog IF 20 exercises control on luminance. More specifically, when an average luminance level is at a specified value or less, a display luminance is increased and when the average luminance level exceeds a specified value, a display luminance is decreased.

A system controlling circuit 26 outputs various control signals to the PDP module 30. The PDP module 30 also has a digital signal processing and controlling circuit 31, a panel portion 32, and a module power source circuit 33 embedding a DC/DC (Direct Current/Direct Current) converter. The digital signal processing and controlling circuit 31 has an input IF signal processing circuit 34, a frame memory 35, a memory controlling circuit 36, and a driver controlling circuit 37.

For example, an average luminance level of a video signal input to the input IF signal processing circuit 34 is calculated by an input signal average luminance level calculating circuit (not shown) in the input IF signal processing circuit 34 and is output as 5-bit data. Also, the PLE controlling circuit 27 sets PLE controlling data according to an average luminance level and inputs the set data to the luminance level controlling circuit (not shown) in the input IF signal processing circuit 34.

The input IF signal processing circuit 34 in the digital signal processing and controlling circuit 31, after having processed various signals, feeds a control signal to the panel portion 32. At the same time, the memory controlling circuit 36 and the driver controlling circuit 37 transmit a memory controlling signal and a driver controlling signal, respectively, to the panel portion 32.

The panel portion 32 has a PDP 70 corresponding to the PDP described in the first to eighth embodiments, a scanning driver 38, a data driver 39 to drive a data electrode, a high-pressure pulse circuit 40 to feed a pulse voltage to the PDP 70 and the scanning driver 38, and a power collecting circuit 41 to collect power from the high-pressure pulse circuit 40.

The PDP 70 includes a panel of, for example, 1365×768 pixels. In the PDP 70, the scanning driver 38 controls a scanning electrode Snot shown) and the data driver 39 controls a data electrode (not shown) in a manner in which a specified pixel out of the 1365×768 pixels is turned ON or OFF to display an image. Moreover, the logic power source feeds power for logical operations to the digital signal processing and controlling circuit 31 and the panel portion 32. The module power source circuit 33 receives direct current power from the display power source and, after having converted a voltage of the direct current power to a specified voltage feeds it to the panel portion 32.

Next, an outline of a method for manufacturing the plasma display device 60 of the eighth embodiment is described. First, by arranging the PDP 70 corresponding to the PDP described in the first to eighth embodiments, the scanning driver 38, the data driver 39, and the high-pressure pulse circuit 40, and the panel portion 32 are formed. Moreover, in addition to the panel portion 32, the digital signal processing and controlling circuit 31 is formed.

By assembling the panel portion 32 and digital signal processing and controlling circuit 31, the module power source circuit 33 and the PDP module 30 is formed. Moreover, in addition to the PDP module 30, the analog IF 20 is formed. Thus, after having fabricated the analog IF 20 and the PDP module 30, separately, by electrically connecting both of them, the plasma display device 60 as shown in FIG. 18 is completed.

By assembling the plasma display device 60 in a form of a module, that is, by constructing the analog IF 20 and the PDP module 30 independently and separately, if a trouble occurs in the plasma display device 60, each of the analog IF 20 and the PDP module 30 can be repaired in a separate manner, with ease, which simplifies the repair process and shortens time required for repairing.

Thus, according to the plasma display device 60, by constructing the plasma display device 60 in a module form, simplification of repair process and shortening of repair time can be achieved.

It is apparent that the present invention is not limited to the above embodiments but may be changed and modified without departing from the scope and spirit of the invention. For example, the method and material for forming the low-resistance conductive portion making up discharge electrodes of the PDP of the present invention are not limited to those employed in the above embodiments and other methods and materials may be used.

1. A plasma display panel comprising:
a first substrate and a second substrate arranged so as to face each other, with discharge gas space being interposed between said first substrate and said second substrate;
a first electrode group made up of two or more scanning electrodes and two or more sustaining electrodes formed on a face of said first substrate facing said second substrate, with a discharge gap being interposed between pairs each being made up of one of said two or more scanning electrodes and one of said two or more sustaining electrodes, in parallel to one another along a first direction;
a second electrode group made up of two or more data electrodes on a face of said second substrate facing said first substrate in a second direction orthogonal to said first direction; and
a discharge cell formed at an intersecting point between said first electrode group and second electrode group;
wherein both each of said two or more scanning electrodes and each of said two or more sustaining electrodes are made up of a transparent conductive portion and a low-resistance conductive portion having a thin film or a thick film containing a metal as a main component and wherein said low-resistance conductive portion is made up of two regions each having, at least, two different film thicknesses in the unit discharge cell.

2. The plasma display panel according to claim 1, wherein said transparent conductive portion and said low-resistance conductive portion are electrically connected to each other via a connecting electrode portion.

3. The plasma display panel according to claim 2, wherein said connecting electrode portion is constructed by using a low-resistance conductive material and a film thickness of said connecting electrode portion is smaller than that of said low-resistance conductive portion.

4. The plasma display panel according to claim 2, wherein a partition wall is formed on said second substrate and said connecting electrode portion is formed in a manner in which said partition wall and said connecting electrode portion are arranged in a manner in which said partition wall and said connecting electrode portion overlap each other or a part of or entire of said second low-resistance conductive portion is placed in a region other than a discharge region partitioned by said partition wall in a manner in which said partition wall and said second low-resistance conductive portion.

5. The plasma display panel according to claim 3, wherein a film thickness of said connecting electrode portion or a film thickness of the mesh-like shaped said first low-resistance conductive portion is approximately 5 μm or less.

6. The plasma display panel according to claim 3, wherein a film thickness of said connecting electrode portion or a thickness of a line making up the mesh-like shaped said first low-resistance conductive portion is approximately 20 μm or less.

7. A plasma display panel comprising:
a first substrate and a second substrate arranged so as to face each other, with discharge gas space being interposed between said first substrate and said second substrate;
a first electrode group made up of two or more scanning electrodes and two or more sustaining electrodes formed on a face of said first substrate facing said second substrate, with a discharge gap being interposed between pairs each being made up of one of said two or more scanning electrodes and one of said two or more sustaining electrodes, in parallel to one another along a first direction;
a second electrode group made up of two or more data electrodes on a face of said second substrate facing said first substrate in a second direction orthogonal to said first direction; and
a discharge cell formed at an intersecting point between said first electrode group and second electrode group;
wherein both each of said two or more scanning electrodes and each of said two or more sustaining electrodes are made up of only a low-resistance conductive portion having a thin film or a thick film containing metal as a main component and wherein said low-resistance conductive portion is made up of two regions each having, at least, two different film thicknesses in the unit discharge cell.

8. The plasma display panel according to claim 7, wherein said low-resistance conductive portion is made up of a first low-resistance conductive portion formed so as to have a mesh-like shape and of a second low-resistance conductive portion being electrically connected to said first low-resistance conductive portion, said first and second low-resistance conductive portions both having a thin film or a thick film containing metal as a main component.

9. The plasma display panel according to claim 8, wherein one of the mesh-like shaped said first low-resistance conductive portion and another of the mesh-like shaped said first low-resistance conductive portion face each other with said discharge gap being interposed between the two mesh-like shaped said low-resistance conductive portions.

10. The plasma display panel according to claim 8, wherein a film thickness of the mesh-like shaped said first low-resistance conductive is smaller than that of said second low-resistance conductive portion.

11. The plasma display panel according to claim 8, wherein a partition wall is formed on said second substrate and said connecting electrode portion is formed in a manner in which said partition wall and said connecting electrode portion are arranged in a manner in which said partition wall and said connecting electrode portion overlap each other or a part of or entire of said second low-resistance conductive portion is placed in a region other than a discharge region partitioned by said partition wall in a manner in which said partition wall and said second low-resistance conductive portion.

12. The plasma display panel according to claim 8, wherein a film thickness of said connecting electrode portion or a film thickness of the mesh-like shaped said first low-resistance conductive portion is approximately 5 μm or less.

13. The plasma display panel according to claim 8, wherein a film thickness of said connecting electrode portion or a thickness of a line making up the mesh-like shaped said first low-resistance conductive portion is approximately 2 μm or less.

14. The plasma display panel according to claim 8, wherein a film thickness of said first mesh-like shaped low-resistance thin film or thick film containing metal as a main component is large in part.

15. A plasma display device comprising:
a plasma display panel including: a first substrate and a second substrate arranged so as to face each other, with discharge gas space being interposed between said first substrate and said second substrate; a first electrode group made up of two or more scanning electrodes and two or more sustaining electrodes formed on a face of said first substrate facing said second substrate, with a discharge gap being interposed between pairs each being made up of one of said two or more scanning electrodes and one of said two or more sustaining electrodes, in parallel to one another along a first direction; a second electrode group made up of two or more data electrodes on a face of said second substrate facing said first substrate in a second direction orthogonal to said first direction; and a discharge cell formed at an intersecting point between said first electrode group and second electrode group; wherein both each of said two or more scanning electrodes and each of said two or more sustaining electrodes are made up of a transparent conductive portion and a low-resistance conductive portion having a thin film or a thick film containing a metal as a main component and wherein said low-resistance conductive portion is made up of two regions each having, at least, two different film thicknesses in the unit discharge cell;
a controlling circuit to control said plasma display panel; and
an interface circuit to make a format conversion of an image signal and to feed the format-converted image signal to said controlling circuit.

16. A plasma display device comprising:
a plasma display panel including; a first substrate and a second substrate arranged so as to face each other, with discharge gas space being interposed between said first substrate and said second substrate; a first electrode group made up of two or more scanning electrodes and two or more sustaining electrodes formed on a face of said first substrate facing said second substrate, with a discharge gap being interposed between pairs each being made up of one of said two or more scanning electrodes and one of said two or more sustaining electrodes, in parallel to one another along a first direction; a second electrode group made up of two or more data electrodes on a face of said second substrate facing said first substrate in a second direction orthogonal to said first direction; and a discharge cell formed at an intersecting point between said first electrode group and second electrode group; wherein both each of said two or more scanning electrodes and each of said two or more sustaining electrodes are made up of only a low-resistance conductive portion having a thin film or a thick film containing metal as a main component and wherein said low-resistance conductive portion is made up of two regions each having, at least, two different film thicknesses in the unit discharge cell;
a controlling circuit to control said plasma display panel; and
an interface circuit to make a format conversion of an image signal and to feed the format-converted image signal to said controlling circuit.
